(19) United States
(12) Patent Application Publication
(10) Pub. No.: US 2023/0036174 A1
(43) Pub. Date: Feb. 2, 2023

(54) LIGHTING METHOD FOR PROMOTING PLANT GROWTH, PLANT LAMP AND APPLICATION THEREOF

(71) Applicant: FUJIAN SANAN SINO-SCIENCE PHOTOBIOTECH CO., LTD., Quanzhou (CN)

(72) Inventors: Yang LI, Quanzhou (CN); Shaohua Li, Quanzhou (CN); Zhuo ZHAN, Quanzhou (CN); Yiqun Chen, Quanzhou (CN); Tingting Wang, Quanzhou (CN); Jian Ma, Quanzhou (CN)

(21) Appl. No.: 17/955,596

(22) Filed: Sep. 29, 2022

Related U.S. Application Data
(62) Division of application No. 17/422,463, filed on Jul. 13, 2021.

(51) Int. Cl. A01G 7/04

(52) U.S. Cl. CPC A01G 7/045

(57) ABSTRACT

The present invention provides a method for promoting plant growth, a plant lamp and application thereof. The method at least includes providing an artificial light source for a growing plant. The light source includes a red light with a peak wavelength of 680-695 nm and a light wave half-width lower than 35 nm; or the light source includes a blue light with a peak wavelength of 410-440 nm and a light wave half-width lower than 35 nm. The plant lamp provides the light source for promoting plant growth. By using the light source in the present invention to irradiate the plant, plant growth is significantly promoted.

### TECHNICAL FIELD

The present invention relates to a lighting method for promoting plant growth, a plant lamp and application thereof.

### BACKGROUND

Light is a basic environmental factor in growth and development of plants. Light is not only a basic energy source for photosynthesis, but also an important regulatory factor in growth and development of plants. Growth and development of plants are not only restricted by light amount or light intensity, but also affected by light quality, namely, radiation of light at different wavelengths and different composition ratios of light.

Photosynthesis provides necessary food, energy and oxygen for survival and reproduction of almost all living things in the biosphere on earth. Sunlight is a basic energy source for photosynthesis of plants. Insufficient sunlight will inevitably limit photosynthesis, and excessive sunlight will cause photoinhibition of photosynthesis and even photodestruction of photosynthetic mechanisms. Plants always live in an environment with fluctuating light, and often encounters insufficient light (especially middle and lower leaves of a canopy in the morning and evening on a cloudy day) and excessive light (upper leaves at noon on a sunny day). Therefore, light-harvesting regulation is necessary for photosynthesis in order to maximize the use of light energy under weak light, and to avoid damage caused by excessive light to photosynthetic mechanisms in strong light. Plants have developed a series of light-harvesting regulation strategies during evolution for a long time. The light-harvesting regulation strategies include fast regulation and slow regulation: fast regulation can occur within a few minutes, such as leaf movement, chloroplast movement, state transition and reversible detachment of a light-harvesting complex (LHCII) from a photosystem II (PSII) core complex (namely reaction center complex); and slow regulation is completed within a few hours or days, such as changes in protein abundance or size of the light-harvesting complex and changes in molecular compositions of leaves. These regulations are performed at different levels in organs (leaf movement), sub-cells (chloroplast movement), thylakoid membranes (state transition) and molecules (changes in contents of chlorophyll (Chl), anthocyanin and stress proteins. Of course, changes in size of the light-harvesting complex include short-term response and long-term adaptation (through gene expression and developmental changes) to changes in light intensity. Scientific researches show that chlorophyll a and phytochrome in a red isomeric form (Pr) have strong absorption peaks at about 660 nm, and chlorophyll b has strong absorption at 640 nm. Therefore, in a traditional plant lighting lamp, the peak wavelength of a red light region is set to be 630-660 nm.

Due to an artificial light-type plant factory, the development of agriculture is no longer dependent on weather, and the regulation of plant growth is achieved by regulating an environment system, a light environment system, a nutrition system and a cultivation method in the factory. Among them, the regulation of a light environment is an important technology related to plant yield and quality and factory operating efficiency. Therefore, according to existing technologies, the regulation of plant yield and quality are mainly achieved by controlling light intensity, light period, a ratio of a red light to a blue light (R/B) and a ratio of a red light to a far-red light (F/FR) in light quality and a cultivation method. There are few reports about technologies for improving the quality and yield by adjusting an energy ratio of a specific wavelength.

For a long time, an energy transfer mechanism of a photosynthetic light-harvesting system is described by a resonance energy transfer provided by Förster (1948), referred to as Förster resonance energy transfer or fluorescence resonance energy transfer (Scholes 2003; Sener et al. 2011). That is, a donor molecule absorbs photon energy, transits into an excited state and then returns to a ground state in a non-radiative transition form to transfer the energy to an adjacent acceptor molecule with low transition energy, so that the acceptor molecule transits into an excited state, and then the energy is successively transferred and finally transferred to a reaction center. Therefore, by providing energy photons which are easy to absorb or energy photons which can achieve a synergistic effect, the energy transfer efficiency can be improved, thereby improving the quality and yield.

In the prior art, there are no reports on improvement of the plant yield and quality by adjusting the peak wavelength.

### SUMMARY

In view of the shortcomings in the prior art, an objective of the present invention is to provide a method for promoting plant growth, a plant lamp and application thereof to solve the problem that the efficiency of methods for promoting plant growth in the prior art is not high.

In a first aspect of the present invention, provided is a method for promoting plant growth, which at least includes providing an artificial light source for a growing plant, and the light source includes a red light with a peak wavelength of 680-695 nm and a light wave half-width lower than 35 nm.

Generally, the plant is cultivated indoors. A greenhouse planting mode may be adopted. The growing plant is a plant which begins to grow after seeding and germination.

Preferably, the light period of the red light is 2-24 h/d, and the light intensity is 10-1000 μmol/m²·s. The peak wavelength of the red light may be 680-690 nm or 690-695 nm.

The light period of the red light may be 2-9 h/d, 9-12 h/d, 12-14 h/d or 14-24 h/d.

The light intensity of the red light may be 10-60 μmol/m²·s, 60-200 μmol/m²·s, 200-250 μmol/m²·s or 250-1000 μmol/m²·s.

Preferably, the light source further includes a blue light with a peak wavelength of 410-480 nm, and a photon number ratio of the red light to the blue light is (15-0.1):1.

More preferably, the light period of the red light and the blue light is 2-24 h/d, and the total light intensity of the red light and the blue light is 10-1000 μmol/m²·s. The peak wavelength of the blue light may be 410-430 nm, 430-435 nm, 435-440 nm or 440-480 nm.

The light period of the blue light may be 2-9 h/d, 9-12 h/d, 12-14 h/d or 14-24 h/d.

The total light intensity of the red light and the blue light may be 10-60 μmol/m²·s, 60-200 μmol/m²·s, 200-250 μmol/m²·s or 250-1000 μmol/m²·s.

The photon number ratio of the red light to the blue light may be (15-4):1, (4-3):1 or (3-0.1):1. More preferably, the light source further includes a far-red light with a peak wavelength of 730-740 nm and a light wave half-width lower than 35 nm, and

a photon number ratio of the far-red light to the entire light source is lower than 50%. It is found through experiments that technical effects of this application can be achieved within this range.

Further, more preferably, the light period of the red light, the blue light and the far-red light is 2-24 h/d, and the total light intensity of the red light, the blue light and the far-red light is 10-1000 μmol/m²·s.

The peak wavelength of the far-red light may be 730-735 nm or 735-740 nm.

The light period of the far-red light may be 2-9 h/d, 9-12 h/d, 12-14 h/d or 14-24 h/d.

The total light intensity of the red light, the blue light and the far-red light may be 10-60 μmol/m²·s, 60-200 μmol/m²·s, 200-250 μmol/m²·s or 250-1000 μmol/m²·s.

Preferably, a cultivation method of the plant includes use of soil, a nutrient solution or a substrate.

When the nutrient solution is used for cultivation, seedlings can be planted on hydroponic modules respectively, ⅔ of roots are soaked in the nutrient solution, and different nutrient solutions are used for different plants. For example, a Hoagland nutrient solution is used for var. ramosa Hort. The EC of the nutrient solution is 1.6-1.8, the pH is 5.5-7.5, the temperature of the nutrient solution is 18° C. to 22° C., and the dissolved oxygen amount is 5-6 mg/L.

Preferably, the method specifically includes seeding and growth management. An existing technology is adopted for seeding. Growth management refers to necessary management for plants after germination, such as fertilization, watering and setting of a light source and environment conditions.

Preferably, the plant may be a vegetable or a Chinese medicinal material.

Preferably, the plant is at least one selected from var. ramosa Hort., Brassica campestris L., Brassica chinensis L., var. ramosa Hort., viola tricolor L. and seedlings of anectochilus roxburhii.

Var. ramosa Hort., commonly known as lactuca sative, is also known as ezicai, maizicai and wozicai and belongs to lactuca of the composite family.

Red Rosa Lettuce belongs to lactuca of the composite family.

Brassica campestris L. ssp. chinensis Makino (var. communis Tsen et Lee) belongs to brassica of cruciferae.

Brassica chinensis L. belongs to brassica of cruciferae.

Anectochilus roxburhii (Wall.) Lindl. is a plant belonging to anoectochilus of orchidaceae, and the whole grass is used as a medicine.

Viola tricolor L. is a biennial or perennial herbal plant belonging to viola of violaceae.

Preferably, the method further includes setting growth environment conditions: the environment temperature is 21° C. to 24° C. during daytime and 18° C. to 20° C. at night, and the humidity is 60% to 80%.

Preferably, the method further includes seeding and germination acceleration. For example, a method for seeding and germination acceleration of var. ramosa Hort. is as follows: full seeds of var. ramosa Hort. are selected, soaked in warm water at 50° C. to 55° C. for 15-20 minutes and then soaked in clear water at 25° C. to 30° C. for 7-8 hours. The soaked seeds are seeded into a seedling sponge block, one seed per hole, a tray is placed under the seedling sponge block, pure water is added with the water level being flushed with the lower surface of the sponge block, water mist is onto the seeds with a sprayer after seeding to maintain surface humidity, and then the seeds are placed in a germination acceleration box for germination acceleration at 22° C. to 25° C., with the humidity maintained at 70% to 80%. Water is sprayed onto the seeds every 12 hours.

In a second aspect of the present invention, provided is a method for promoting plant growth, which at least includes providing an artificial light source for a growing plant. The light source includes a blue light with a peak wavelength of 410-440 nm and a light wave half-width lower than 35 nm. Generally, the plant is cultivated indoors. A greenhouse planting mode may be adopted.

The growing plant is a plant which begins to grow after seeding and germination.

Preferably, the light period of the blue light is 2-24 h/d, and the light intensity of the blue light is 10-1000 μmol/m²·s.

The peak wavelength of the blue light may be 410-430 nm, 430-435 nm or 435-440 nm. The light period of the blue light may be 2-9 h/d, 9-12 h/d, 12-14 h/d or 14-24 h/d.

The light intensity of the blue light may be 10-60 μmol/m²·s, 60-200 μmol/m²·s, 200-250 μmol/m²·s or 250-1000 μmol/m²·s.

Preferably, the light source further includes a red light with a peak wavelength of 630-700 nm, and a photon number ratio of the red light to the blue light is (15-0.1):1.

More preferably, the light period of the red light and the blue light is 2-24 h/d, and the total light intensity of the red light and the blue light is 10-1000 μmol/m²·s. The peak wavelength of the red light may be 630-660 nm, 660-680 nm, 680-695 nm or 695-700 nm.

The light period of the red light may be 2-9 h/d, 9-12 h/d, 12-14 h/d or 14-24 h/d.

The total light intensity of the red light and the blue light may be 10-60 μmol/m²·s, 60-200 μmol/m²·s, 200-250 μmol/m²·s or 250-1000 μmol/m²·s.

The photon number ratio of the red light to the blue light may be (15-4):1, (4-3):1 or (3-0.1):1. Preferably, a cultivation method of the plant includes use of soil, a nutrient solution or a substrate.

When the nutrient solution is used for cultivation, seedlings can be planted on hydroponic modules respectively, ⅔ of roots are soaked in the nutrient solution, and different nutrient solutions are used for different plants. For example, a Hoagland nutrient solution is used for var. ramosa Hort. The EC of the nutrient solution is 1.6-1.8, the pH is 5.5-7.5, the temperature of the nutrient solution is 18° C. to 22° C., and the dissolved oxygen amount is 5-6 mg/L.

Preferably, the method specifically includes seeding and growth management. An existing technology is adopted for seeding. Growth management refers to necessary management for plants after germination, such as fertilization, watering and setting of a light source and environment conditions.

Preferably, the plant may be a vegetable or a Chinese medicinal material.

Preferably, the plant is at least one selected from var. ramosa Hort., Brassica campestris L., Brassica chinensis L., var. ramosa Hort., viola tricolor L. and seedlings of anectochilus roxburhii.

Var. ramosa Hort., commonly known as lactuca sative, is also known as ezicai, maizicai and wozicai and belongs to lactuca of the composite family.

Var. ramosa Hort. belongs to lactuca of the composite family.

Brassica campestris L. ssp. chinensis Makino (var. communis Tsen et Lee) belongs to brassica of cruciferae.

Brassica chinensis L. belongs to brassica of cruciferae.

Anectochilus roxburhii (Wall.) Lindl. is a plant belonging to anoectochilus of orchidaceae, and the whole grass is used as a medicine.

Viola tricolor L. is a biennial or perennial herbal plant belonging to viola of violaceae.

Preferably, the method further includes setting growth environment conditions: the environment temperature is 21° C. to 24° C. during daytime and 18° C. to 20° C. at night, and the humidity is 60% to 80%.

Preferably, the method further includes seeding and germination acceleration. For example, a method for seeding and germination acceleration of var. ramosa Hort. is as follows: full seeds of var. ramosa Hort. are selected, soaked in warm water at 50° C. to 55° C. for 15-20 minutes and then soaked in clear water at 25° C. to 30° C. for 7-8 hours. The soaked seeds are seeded into a seedling sponge block, one seed per hole, a tray is placed under the seedling sponge block, pure water is added with the water level being flushed with the lower surface of the sponge block, water mist is onto the seeds with a sprayer after seeding to maintain surface humidity, and then the seeds are placed in a germination acceleration box for germination acceleration at 22° C. to 25° C., with the humidity maintained at 70% to 80%. Water is sprayed onto the seeds every 12 hours.

In a third aspect of the present invention, provided is a plant lamp, which is capable of providing the light source above. The light source can emit lights with the spectral characteristics above.

The plant lamp can be obtained by changing a light-emitting diode of an LED light in the prior art. In a fourth aspect of the present invention, provided is application of the plant lamp above in promoting plant growth.

As described above, a method for increasing the yield of leafy vegetables based on a multi-band spectrum in the present invention has the following beneficial effects: the yield of plants is significantly increased by adopting the technical solutions in the present invention, especially a synergistic effect is achieved when the red light, the blue light and the far-red light are used at the same time, such that better growth of plants is promoted.

### DETAILED DESCRIPTION

The implementations of the present invention are described below through specific examples. Those skilled in the art can easily understand the other advantages and effects of the present invention from the content disclosed in this specification. The present invention may also be implemented or applied through other different specific implementations. Various details in this specification may also be modified or changed based on different viewpoints and applications without departing from the spirit of the present invention.

TABLE 1
Materials and manufacturers

| Material | Manufacturer | Note (article number) |
|---|---|---|
| Seeds of var. ramosa Hort. | Shanghai Wells Seed Co., Ltd. | 31201600076 |
| Seeds of brassica campestris L. | Xiamen Zhongxia Seed Co., Ltd. | 53232800201600074 |
| Seeds of var. ramosa Hort. | Harbin Just-Team Agriculture | 6209201700119302 |
| | Development Co., Ltd. | |
| Seedlings of anectochilus | Fujian Sanan Sino-Science | |
| roxburhii | Photobiotech Co., Ltd | |
| Seeds of viola tricolor L. | Japan Takii | |

### Embodiments 1-20 and Comparative Examples 1-2 Cultivation of Var. Ramosa Hort

(1) Seeding and germination acceleration: Full seeds of var. ramosa Hort. were selected, soaked in warm water at 50° C. for 20 minutes and then soaked in clear water at 30° C. for 8 hours. The soaked seeds were seeded into a seedling sponge block, one seed per hole, a tray was placed under the seedling sponge block, pure water was added with the pure water level being flushed with the lower surface of the sponge block, water mist was onto the seeds with a sprayer after seeding to maintain surface humidity, then the seeds were placed in a germination acceleration box for germination acceleration at 25° C., with the humidity maintained at 80%. Water was sprayed onto the seeds every 12 hours.

(2) Growth management: Seedlings of var. ramosa Hort. were planted on hydroponic modules respectively when 4-5 leaves and one heart grew out, and ⅔ of roots were soaked in a nutrient solution. The EC of the nutrient solution was 1.8, the pH was 7.5, the temperature of the nutrient solution was 22° C., and the dissolved oxygen amount was 6 mg/L. Environment temperature conditions were 23° C. during daytime and 18° C. at night. Light source parameters (including the peak wavelength of light, a photon number ratio, light period and light intensity) were set, and planting was performed for 20 days.

Var. ramosa Hort. is cultivated by using the cultivation method above, the light source parameters in step (2) are changed in each embodiment and comparative example, a fresh weight per plant obtained in each embodiment and comparative example is weighed, and thus an average weight is obtained. Experimental results are shown in Table 2:

TABLE 2

| | Spectral composition | | | | | | | | | Fresh |
|---|---|---|---|---|---|---|---|---|---|---|
| | | | | | | | Photon number | | | weight of |
| | Red light 1 | | Blue light | | Red light 2 | | ratio of light | | | overground |
| | Peak | Half- | Peak | Half- | Peak | Half- | source (red light | Light | Light | part of |
| | wavelength | width | wavelength | width | wavelength | width | 1:blue light: | intensity | period | plant |
| Number | (nm) | (nm) | (nm) | (nm) | (nm) | (nm) | red light 2) | (μmol/m² · s) | (h/d) | (g/plant) |
| Comparative | 660 | 20 | | | | | None | 250 | 9 | 42.81 |
| Example 1 (red | | | | | | | | | | |
| light) | | | | | | | | | | |
| Embodiment 1 | 680 | 20 | | | | | None | 250 | 9 | 46.09 |
| Embodiment 2 | 680 | 25 | | | | | None | 250 | 9 | 46.05 |
| Embodiment 3 | 685 | 27 | | | | | None | 250 | 9 | 47.23 |
| Embodiment 4 | 690 | 25 | | | | | None | 250 | 9 | 51.24 |
| Embodiment 5 | 693 | 34 | | | | | None | 250 | 9 | 54.94 |
| Embodiment 6 | 695 | 25 | | | | | None | 250 | 9 | 55.89 |
| Embodiment 7 | 695 | 30 | | | | | None | 250 | 9 | 55.71 |
| Comparative | | | 450 | 20 | | | None | 250 | 9 | 35.48 |
| Embodiment 2 | | | | | | | | | | |
| (blue light) | | | | | | | | | | |
| Embodiment 8 | | | 410 | 20 | | | None | 250 | 9 | 37.82 |
| Embodiment 9 | | | 435 | 20 | | | None | 250 | 9 | 41.02 |
| Embodiment 10 | | | 440 | 20 | | | None | 250 | 9 | 38.87 |
| Embodiment 11 | 680 | 25 | 430 | 20 | | | 3:1 | 250 | 9 | 54.97 |
| Embodiment 12 | 695 | 25 | 440 | 20 | | | 3:1 | 250 | 9 | 64.80 |
| Embodiment 13 | 695 | 25 | 435 | 20 | | | 3:1 | 250 | 9 | 67.22 |
| Embodiment 14 | 695 | 25 | 410 | 20 | | | 3:1 | 250 | 9 | 60.12 |
| Embodiment 15 | 695 | 25 | 480 | 32 | | | 3:1 | 250 | 9 | 59.36 |
| Embodiment 16 | 630 | 20 | 435 | 20 | | | 3:1 | 250 | 9 | 57.24 |
| Embodiment 17 | 660 | 20 | 435 | 20 | | | 3:1 | 250 | 9 | 59.37 |
| Embodiment 18 | 695 | 25 | 435 | 20 | | | 0.1:1 | 250 | 9 | 45.45 |
| Embodiment 19 | 695 | 25 | 435 | 20 | | | 15:1 | 250 | 9 | 59.74 |
| Embodiment 20 | 680 | 25 | 430 | 20 | 735 | 23 | 3:1:1 | 250 | 9 | 66.22 |

The experiments show that compared with a traditional technical solution using a red light at 660 nm or a blue light at 450 nm, yields of plants are increased by 30.5% and 15.6% respectively to the maximum extent by using the solution of the present invention, a significant promoting effect is achieved, and a better promoting effect is achieved when a red light and a blue light are used at the same time or a red light, a blue light and a far-red light are used at the same time.

### Embodiments 21-40 and Comparative Embodiments 3-4 Cultivation of Brassica campestris L

(1) Seeding and germination acceleration: Full seeds of Brassica campestris L. were selected and seeded into a seedling sponge block, one seed per hole, a tray was placed under the seedling sponge block, pure water was added with the water level being flushed with the lower surface of the sponge block, water mist is sprayed onto the seeds with a sprayer after seeding to maintain surface humidity, then the seeds were placed in a germination acceleration box for germination acceleration at 25° C., with the humidity maintained at 80%. Water was sprayed onto the seeds every 12 hours.

(2) Growth management: Seedlings of Brassica campestris L. were planted on hydroponic modules respectively when 4-5 leaves and one heart grew out, and ⅔ of roots were soaked in a nutrient solution. The EC of the nutrient solution was 1.6, the pH was 6.5, the temperature of the nutrient solution was 20° C., and the dissolved oxygen amount was 5.5 mg/L. Environment temperature conditions include 22° C. during daytime and 20° C. at night. Light source parameters (including a peak wavelength of a light, a photon number ratio, a light period and light intensity) are set, and planting is performed for 15 days.

Brassica campestris L. is cultivated by using the cultivation method above, the light source parameters in step (2) are changed in each embodiment and comparative example, a fresh weight per plant obtained in each embodiment and comparative example is weighed, and thus an average weight is obtained. Experimental results are shown in Table 3:

TABLE 3

| | Spectral composition | | | | | | | | | Fresh |
|---|---|---|---|---|---|---|---|---|---|---|
| | | | | | | | Photon number | | | weight of |
| | Red light 1 | | Blue light | | Red light 2 | | ratio of light | | | overground |
| | Peak | Half- | Peak | Half- | Peak | Half- | source (red light | Light | Light | part of |
| | wavelength | width | wavelength | width | wavelength | width | 1:blue light: | intensity | period | plant |
| Number | (nm) | (nm) | (nm) | (nm) | (nm) | (nm) | red light 2) | (μmol/m² · s) | (h/d) | (g/plant) |
| Comparative | 660 | 20 | | | | | None | 250 | 14 | 52.23 |
| Example 3 (red | | | | | | | | | | |
| light) | | | | | | | | | | |
| Embodiment 21 | 680 | 20 | | | | | None | 250 | 14 | 58.60 |
| Embodiment 22 | 680 | 25 | | | | | None | 250 | 14 | 58.47 |
| Embodiment 23 | 685 | 27 | | | | | None | 250 | 14 | 59.13 |
| Embodiment 24 | 690 | 25 | | | | | None | 250 | 14 | 61.82 |
| Embodiment 25 | 693 | 34 | | | | | None | 250 | 14 | 63.44 |
| Embodiment 26 | 695 | 25 | | | | | None | 250 | 14 | 65.46 |
| Embodiment 27 | 695 | 30 | | | | | None | 250 | 14 | 65.39 |
| Comparative | | | 450 | 20 | | | None | 250 | 14 | 48.69 |
| Example 4 (blue | | | | | | | | | | |
| light) | | | | | | | | | | |
| Embodiment 28 | | | 410 | 20 | | | None | 250 | 14 | 51.21 |
| Embodiment 29 | | | 435 | 20 | | | None | 250 | 14 | 59.86 |
| Embodiment 30 | | | 440 | 20 | | | None | 250 | 14 | 55.13 |
| Embodiment 31 | 680 | 25 | 430 | 20 | | | 4:1 | 250 | 14 | 75.12 |
| Embodiment 32 | 695 | 25 | 410 | 20 | | | 4:1 | 250 | 14 | 79.24 |
| Embodiment 33 | 695 | 25 | 480 | 32 | | | 4:1 | 250 | 14 | 75.23 |
| Embodiment 34 | 630 | 20 | 435 | 20 | | | 4:1 | 250 | 14 | 72.04 |
| Embodiment 35 | 660 | 20 | 435 | 20 | | | 4:1 | 250 | 14 | 73.68 |
| Embodiment 36 | 695 | 25 | 440 | 20 | | | 4:1 | 250 | 14 | 84.46 |
| Embodiment 37 | 695 | 25 | 435 | 20 | | | 4:1 | 250 | 14 | 90.18 |
| Embodiment 38 | 695 | 25 | 435 | 20 | | | 0.1:1 | 250 | 14 | 68.41 |
| Embodiment 39 | 695 | 25 | 435 | 20 | | | 15:1 | 250 | 14 | 75.16 |
| Embodiment 40 | 680 | 25 | 430 | 20 | 740 | 23 | 4:1:1 | 250 | 14 | 81.12 |

The experiments show that compared with a traditional technical solution using a red light at 660 nm or a blue light at 450 nm, yields of plants are increased by 25.3% and 22.9% respectively to the maximum extent by using the solution of the present invention, a significant promoting effect is achieved, and a better promoting effect is achieved when a red light and a blue light are used at the same time or a red light, a blue light and a far-red light are used at the same time.

### Embodiments 41-60 and Comparative Examples 5-6 Cultivation of Var. Ramosa Hort

(1) Seeding and germination acceleration: Full seeds of var. ramosa Hort. were selected and seeded into a seedling sponge block, one seed per hole, a tray was placed under the seedling sponge block, pure water was added with the water level being flushed with the lower surface of the sponge block, water mist was sprayed onto the seeds with a sprayer after seeding to maintain surface humidity, then the seeds were placed in a germination acceleration box for germination acceleration at 24° C., with the humidity maintained at 75%. Water was sprayed onto the seeds every 12 hours.

(2) Growth management: Seedlings of var. ramosa Hort. were planted on hydroponic modules respectively when 4-5 leaves and one heart grew out, and ⅔ of roots were soaked in a nutrient solution. The EC of the nutrient solution was 1.6, the pH was 6, the temperature of the nutrient solution was 20° C., and the dissolved oxygen amount was 5 mg/L. Environment temperature conditions were 23° C. during daytime and 18° C. at night. Light source parameters (including a light type, a wave band, a photon number ratio, a light period and light intensity) are set, and planting is performed for 22 days.

Var. ramosa Hort. is cultivated by using the cultivation method above, the light source parameters in step (2) are changed in each embodiment and comparative example, a fresh weight per plant obtained in each embodiment and comparative example is weighed, and thus an average weight is obtained. Experimental results are shown in Table 4:

TABLE 4

| | Spectral composition | | | | | | | | | Fresh |
|---|---|---|---|---|---|---|---|---|---|---|
| | | | | | | | Photon number | | | weight of |
| | Red light 1 | | Blue light | | Red light 2 | | ratio of light | | | overground |
| | Peak | Half- | Peak | Half- | Peak | Half- | source (red light | Light | Light | part of |
| | wavelength | width | wavelength | width | wavelength | width | 1:blue light: | intensity | period | plant |
| Number | (nm) | (nm) | (nm) | (nm) | (nm) | (nm) | red light 2) | (μmol/m² · s) | (h/d) | (g/plant) |
| Comparative | 660 | 20 | | | | | None | 250 | 12 | 58.34 |
| Example 5 (red | | | | | | | | | | |
| light) | | | | | | | | | | |
| Embodiment 41 | 680 | 20 | | | | | None | 250 | 12 | 64.67 |
| Embodiment 42 | 680 | 25 | | | | | None | 250 | 12 | 64.59 |
| Embodiment 43 | 685 | 27 | | | | | None | 250 | 12 | 65.35 |
| Embodiment 44 | 690 | 25 | | | | | None | 250 | 12 | 68.04 |
| Embodiment 45 | 693 | 34 | | | | | None | 250 | 12 | 70.11 |
| Embodiment 46 | 695 | 25 | | | | | None | 250 | 12 | 73.15 |
| Embodiment 47 | 695 | 30 | | | | | None | 250 | 12 | 73.10 |
| Comparative | | | 450 | 20 | | | None | 250 | 12 | 42.35 |
| Example 6 (blue | | | | | | | | | | |
| light) | | | | | | | | | | |
| Embodiment 48 | | | 410 | 20 | | | None | 250 | 12 | 44.68 |
| Embodiment 49 | | | 435 | 20 | | | None | 250 | 12 | 52.64 |
| Embodiment 50 | | | 440 | 20 | | | None | 250 | 12 | 48.57 |
| Embodiment 51 | 680 | 25 | 430 | 20 | | | 3:1 | 250 | 12 | 75.46 |
| Embodiment 52 | 695 | 25 | 410 | 20 | | | 3:1 | 250 | 12 | 75.14 |
| Embodiment 53 | 695 | 25 | 480 | 32 | | | 3:1 | 250 | 12 | 72.36 |
| Embodiment 54 | 630 | 20 | 435 | 20 | | | 3:1 | 250 | 12 | 68.57 |
| Embodiment 55 | 660 | 20 | 435 | 20 | | | 3:1 | 250 | 12 | 70.16 |
| Embodiment 56 | 695 | 25 | 440 | 20 | | | 3:1 | 250 | 12 | 80.16 |
| Embodiment 57 | 695 | 25 | 435 | 20 | | | 3:1 | 250 | 12 | 82.42 |
| Embodiment 58 | 695 | 25 | 435 | 20 | | | 0.1:1 | 250 | 12 | 55.68 |
| Embodiment 56 | 695 | 25 | 435 | 20 | | | 15:1 | 250 | 12 | 78.12 |
| Embodiment 60 | 680 | 25 | 430 | 20 | 730 | 23 | 3:1:1 | 250 | 12 | 81.46 |

The experiments show that compared with a traditional technical solution using a red light at 660 nm or a blue light at 450 nm, yields of plants are increased by 25.3% and 24.2% respectively to the maximum extent by using the solution of the present invention, a significant promoting effect is achieved, and a better promoting effect is achieved when a red light and a blue light are used at the same time or a red light, a blue light and a far-red light are used at the same time.

### Embodiments 61-79 and Comparative Examples 7-8 Cultivation of Seedlings of Anectochilus Roxburhii

(1) Seedlings of anectochilus roxburhii were removed from a tissue culture flask, a substrate was rinsed out with clear water, it should be ensured that stems and roots were intact during rinsing, the seedlings were soaked in a 0.1% potassium permanganate solution for 5 minutes after rinsing for disinfection and sterilization, and the sterilized seedlings were placed in a sterile pot for later use.

(2) The seedlings were respectively planted in a mixed substrate prepared from peat soil, vermiculite and river sand at a ratio of 1:1:1 (the substrate was sterilized at high pressure) after potassium permanganate on surfaces of anectochilus roxburhii leaves evaporated out, a specific nutrient solution was used to replace sterile water for mixing, and the soil moisture was 80%;

(3) The substrate was placed into a planting pot with a size of 25 cm*25 cm*25 cm; after the seedlings of anectochilus roxburhii were respectively planted at a specific plant gap of 2 cm, the whole cultivation pot was sealed and moisturized.

(4) The pot was cultivated in an artificial light environment, the light quality of the light environment was X, the light period was 14 h/d, the light intensity was 60±5 μmol/m²·s, the temperature during daytime and at night was 23° C. and 18° C. respectively, and planting was performed for 120 days.

The seedlings of anectochilus roxburhii are cultivated by using the cultivation method above, and light source parameters in step (4) are changed in each embodiment and comparative example. A fresh weight and a dry weight per plant obtained in each embodiment and comparative example are weighed, and thus the average weight and weight percentage of flavone are obtained. Experimental results are shown in Table 5:

TABLE 5

| | Spectral composition | | | | | | | | | | | |
|---|---|---|---|---|---|---|---|---|---|---|---|---|
| | | | | | | | Photon | | | | | |
| | | | | | | | number ratio | | | Biological index | | |
| | | | | | | | of light | | | Fresh | Dry | |
| | Red light 1 | | Blue light | | Red light 2 | | source (red | | | weight | weight | |
| | Peak | Half- | Peak | Half- | Peak | Half- | light 1:blue | Light | Light | per | per | |
| | wavelength | width | wavelength | width | wavelength | width | light:red | intensity | period | plant | plant | Flavone |
| Number | (nm) | (nm) | (nm) | (nm) | (nm) | (nm) | light 2) | (μmol/m² · s) | (h/d) | (g) | (mg) | (%) |
| Comparative | 660 | 20 | | | | | | 60 | 14 | 2.51 | 187.24 | 2.71 |
| Example 7 (red | | | | | | | | | | | | |
| light) | | | | | | | | | | | | |
| Embodiment 61 | 680 | 20 | | | | | | 60 | 14 | 2.73 | 207.5 | 2.87 |
| Embodiment 62 | 680 | 25 | | | | | | 60 | 14 | 2.79 | 207.7 | 2.90 |
| Embodiment 63 | 685 | 27 | | | | | | 60 | 14 | 2.81 | 208.10 | 2.93 |
| Embodiment 64 | 690 | 25 | | | | | | 60 | 14 | 2.80 | 208.41 | 3.01 |
| Embodiment 65 | 693 | 34 | | | | | | 60 | 14 | 2.84 | 210.6 | 3.09 |
| Embodiment 66 | 695 | 25 | | | | | | 60 | 14 | 2.89 | 210.92 | 3.26 |
| Embodiment 67 | 695 | 30 | | | | | | 60 | 14 | 2.88 | 210.81 | 3.20 |
| Comparative | | | 450 | 20 | | | | 60 | 14 | 2.21 | 170.25 | 3.37 |
| Example 8 (blue | | | | | | | | | | | | |
| light) | | | | | | | | | | | | |
| Embodiment 68 | | | 410 | 20 | | | | 60 | 14 | 2.41 | 206.92 | 3.43 |
| Embodiment 69 | | | 435 | 20 | | | | 60 | 14 | 2.58 | 213.67 | 3.84 |
| Embodiment 70 | | | 440 | 20 | | | | 60 | 14 | 2.51 | 203.17 | 4.17 |
| Embodiment 71 | 695 | 25 | 435 | 20 | | | 3:1 | 60 | 14 | 3.43 | 258.12 | 3.62 |
| Embodiment 72 | 695 | 25 | 410 | 20 | | | 3:1 | 60 | 14 | 3.14 | 227.03 | 3.42 |
| Embodiment 73 | 695 | 25 | 480 | 32 | | | 3:1 | 60 | 14 | 3.08 | 225.81 | 3.36 |
| Embodiment 74 | 630 | 20 | 435 | 20 | | | 3:1 | 60 | 14 | 2.98 | 217.54 | 3.18 |
| Embodiment 75 | 660 | 20 | 435 | 20 | | | 3:1 | 60 | 14 | 3.05 | 222.65 | 3.22 |
| Embodiment 76 | 680 | 25 | 410 | 20 | | | 3:1 | 60 | 14 | 3.23 | 247.34 | 3.48 |
| Embodiment 77 | 695 | 25 | 435 | 20 | | | 0.1:1 | 60 | 14 | 2.86 | 199.58 | 3.44 |
| Embodiment 78 | 695 | 25 | 435 | 20 | | | 15:1 | 60 | 14 | 3.06 | 219.14 | 3.09 |
| Embodiment 79 | 680 | 25 | 440 | 20 | 735 | 23 | 3:1:1 | 60 | 14 | 3.34 | 240.16 | 3.55 |

The experiment results show that compared with a traditional technical solution using a red light at 660 nm, the fresh weight, the dry weight and the content of flavone are increased by 15.1%, 12.6% and 20.2% respectively to the maximum extent by using the solution of the present invention; and compared with a traditional technical solution using a blue light at 450 nm, the fresh weight, the dry weight and the content of flavone are increased by 16.7%, 25.5% and 23.7% respectively to the maximum extent by using the solution of the present invention, a significant promoting effect is achieved; and a better promoting effect is achieved when a red light and a blue light are used at the same time or a red light, a blue light and a far-red light are used at the same time.

### Embodiments 80-86 and Comparative Example 9 Cultivation of Viola Tricolor L

(1) Seeding and germination acceleration: Full seeds of viola tricolor L. were selected, soaked in clear water for 4 hours and then seeded into a wet seedling sponge block, one seed per hole, a tray was placed under the seedling sponge block, pure water was added with the water level being flushed with the lower surface of the sponge block, the seeds were placed in a germination acceleration box for germination acceleration at 24° C. after seeding, with the humidity maintained at 70%, and water mist was sprayed onto the seeds every 24 hours.

(2) Growth management: Seedlings of viola tricolor L. were planted on hydroponic modules respectively when 4-5 leaves and one heart grew out, and ⅔ of roots were soaked in a nutrient solution. The EC of the nutrient solution was 1.6, the pH was 6.0, the temperature of the nutrient solution was 20° C., and the dissolved oxygen amount was 5 mg/L. Environment temperature conditions were 23° C. during daytime and 18° C. at night. Light source parameters (including light type, wave bands, a photon number ratio, light period and light intensity) are set, and data are collected once every week after planting is performed for 20 days.

(3) The data which can be collected include the number of flowers, plant height and crown diameter of viola tricolor L. in embodiments and comparative examples. Experimental results are shown in Table 6:

TABLE 6

| | Peak | Half-width | | | Number | | | |
|---|---|---|---|---|---|---|---|---|
| | wavelength of | of a | Light | Light | of | Plant | Crown | |
| | a red light | red light | intensity | period | flowers | height | Diameter | |
| Number | (nm) | (nm) | (μmol/m² · s) | (h/d) | (flower) | (cm) | (cm) | |
| Comparative | 660 | 20 | 200 | 14 | 1109 | 18 | 19 | *20 |
| Example 9 (red | | | | | | | | |
| light) | | | | | | | | |
| Embodiment 80 | 695 | 30 | 200 | 14 | 1310 | 21 | 23 | *23 |
| Embodiment 81 | 695 | 25 | 200 | 14 | 1317 | 21 | 23 | *23 |
| Embodiment 82 | 693 | 34 | 200 | 14 | 1299 | 21 | 23 | *23 |
| Embodiment 83 | 690 | 25 | 200 | 14 | 1289 | 21 | 22 | *23 |
| Embodiment 84 | 685 | 27 | 200 | 14 | 1268 | 20 | 22 | *23 |
| Embodiment 85 | 680 | 25 | 200 | 14 | 1249 | 20 | 21 | *23 |
| Embodiment 86 | 680 | 20 | 200 | 14 | 1242 | 20 | 21 | *23 |

The experiment results show that compared with a traditional technical solution using a red light at 660 nm, the number of flowers is increased by 18% to the maximum extent by using the solution of the present invention, and a significant promoting effect is achieved.

The embodiments above are used to illustrate implementations disclosed in the present invention and should not be construed as limitations to the present invention. In addition, various modifications and changes in methods and compositions listed in the present invention are easily understood by those skilled in the art without departing from the scope and spirit of the present invention. Although the present invention is described in detail by combining with various specific preferred embodiments of the present invention, it should be understood that the present invention should not be limited to these specific embodiments. In fact, various modifications described above which are easily understood by those skilled in the art and used to obtain the present invention should be included in the scope of the present invention.

What is claimed is:

1. A method for promoting plant growth, at least comprising providing an artificial light source for a growing plant, wherein the light source comprises a blue light with a peak wavelength of 410-440 nm and a light wave half-width lower than 35 nm.

2. The method according to claim 1, wherein the light source further comprises a red light with a peak wavelength of 630-700 nm, and a photon number ratio of the red light to the blue light is (15-0.1):1.

3. The method according to claim 1, wherein a cultivation method of the plant comprises use of soil, a nutrient solution or a substrate.
